(19) United States
(12) Patent Application Publication
(10) Pub. No.: US 2012/0009096 A1
(43) Pub. Date: Jan. 12, 2012

(54) APPARATUS FOR SAFELY GENERATING HYDROGEN GAS THROUGH THE REACTION OF METALLIC SODIUM WITH WATER

(75) Inventor: Masahide Ichikawa, TOKYO (JP)

(73) Assignees: SABURO KAMATA, HONOLULU, HI (US); MASAHIDE ICHIKAWA, TOKYO (JP)

(21) Appl. No.: 12/527,502

(22) PCT Filed: Jun. 8, 2009
(86) PCT No.: PCT/JP09/60453

§ 371 Date: Aug. 17, 2009

(30) Foreign Application Priority Data
Mar. 30, 2009 (JP) 2009-083015

(51) Int. Cl. B01L 3/00; B01J 8/00

(52) U.S. Cl. 422/500; 422/162

(57) ABSTRACT

This is an apparatus invented to generate hydrogen gas safely using the reaction of metallic sodium and water. Metallic sodium is cut into thin slices using a guillotine-type cutter and fed into the feed opening in the upper part of a pipe inserted in the water layer in a sealed water tank. Dropping in the metallic sodium causes the metallic sodium to settle and through contact with the water generate hydrogen gas. The lower end of the feed pipe is adjoined with adhesive to an opening in the water ejection pipe of the water jet pump in such a manner that the pipe and pump form one unit. The metallic sodium released in the tank is immediately forced from the tap water jet pump into the water layer, reacts with the water, and generates the hydrogen gas. The hydrogen gas is kept in a storage tank. The storage tank is equipped with a sensor that gauges the pressure and when the pressure reaches a certain point within the tank it stops the action of the cutter and the supply of metallic sodium is suspended.

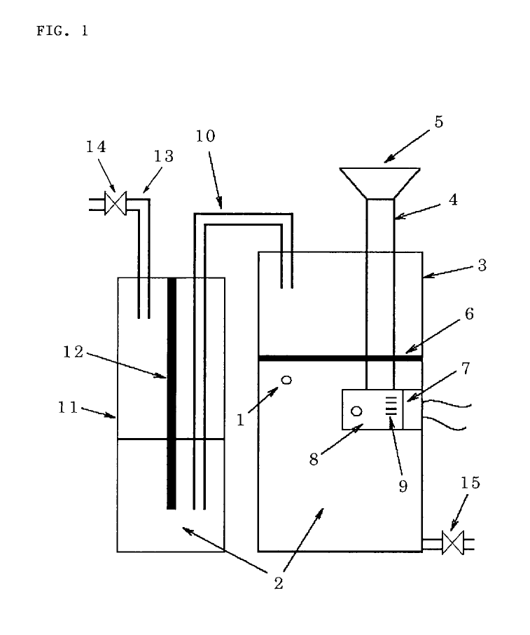

### TECHNICAL FIELD

This invention relates to an apparatus for obtaining hydrogen gas through the reaction caused when metallic sodium is introduced into water.

### BACKGROUND OF THE INVENTION

Since hydrogen gas found its application as a fuel for fuel cells, hydrogen gas has rapidly attracted attention as a clean energy source.

It is common knowledge among chemists that when metallic sodium is caused to react with water hydrogen gas will be produced. However, metallic sodium has not been considered a material with a varied range of applications; the tendency has been to use it only as an experimental material for the production of hydrogen gas. This is because metallic sodium is a highly hazardous substance that oxidizes very quickly when it comes in contact with air and when it comes in contact with water reacts rapidly to produce hydrogen gas and immediately ignites. Therefore, extreme care must be taken when handling this material.

At the same time, sodium being the 6th most common element in the earth's crust, technology for the industrial production of metallic sodium is well established. The relatively low melting point of metallic sodium, 98 degrees C., the specific gravity of less than 1, and the specific heat of only 0.3 make it useful as a coolant for fast-breeder reactors. It is also used to produce alcoholates by causing it to react with alcohols in an insert gas atmosphere.

### PRIOR ART DOCUMENTS

Patent Documents:

Patent Document 1: JP-2006-122864

Patent Document 2: Patent Application 2008-322249 Specification

### BRIEF SUMMARY OF THE INVENTION

Problems Solved by the Invention

For the reasons outlined above—that is, the nature of metallic sodium which makes it difficult to handle and the safety factors—the reaction of metallic sodium with water to generate hydrogen gas has not been much explored. So the problem was how to safely generate hydrogen gas by bringing metallic sodium into contact with water.

Means for Resolving the Difficulties

The inventor developed an apparatus that uses a guillotine cutter to slice molded metallic sodium into thin chips (plates or other shapes), then introduces them directly into water to produce the hydrogen gas. A water jet pump in the water tank stirs the liquid, causing the metallic sodium to react safely and extremely efficiently with the water to generate the hydrogen gas.

In other words, the present invention feeds fine bar-shaped or plate-shaped cut pieces of metallic sodium into the water layer or alternatively oil layer inside a sealed tank to generate the hydrogen gas. The opening through which the metallic sodium is introduced into the water extends well into the middle of the water; the water jet pump positioned in the middle of the water layer has a water ejection pipe, well in the water layer, the pump is attached at a hole in the midsection of the water ejection pipe, and when the water jet pump is activated, the metallic sodium that has been introduced is pushed along with the emitted water into the middle of the water layer where the metallic sodium reacts with the water to produce the hydrogen gas.

Advantages of the Invention

The present invention provides for metallic sodium to react with water and generate hydrogen gas which can be utilized as a new energy source. For countries with little or no petroleum resources this process offers a readily accessible energy source. Metallic sodium can be obtained by the sodium chloride electrolysis method or by the amalgam method.

### BRIEF DESCRIPTION OF THE SEVERAL VIEWS OF THE DRAWING

Drawing 1 is a schematic view illustrating the outline of the hydrogen gas generating apparatus according to the present invention.

### DETAILED DESCRIPTION OF THE INVENTION

The present invention is hereinafter described with reference to the diagram. The metallic sodium to be used in this invention is cut into fine pieces so it will react readily with water. A guillotine style cutter is the preferable cutter to obtain the necessary finely shaped pieces, though of course other styles of cutting instruments may be used. The present explanation discloses an invention that makes use of the guillotine cutter. This type of guillotine cutter is easily available on the market. In this style of cutter the action of the cam and spring cause the upper blade to move up and down, slicing the material placed between the upper and lower blades.

The metallic sodium placed on the feed belt is pushed into the space between the upper and lower blades when the upper blade is raised. On the output side of the cutter is a stopper made of metal, which is connected by electric wiring to a cam device that causes the upper cutter blade to drop. As the expelled metallic sodium comes in contact with the stopper an electric current flows between them releasing an electric signal to the upper blade, which then drops. When the metallic sodium has been cut the electric current ceases to flow, switching the cam drive to off. The upper blade is suspended by the spring, and when the switch is turned off the power of the spring pulls the upper blade back to the upper position. In this way, the size of the metallic sodium slice is controlled.

Drawing 1 shows a general outline of the apparatus for generating hydrogen gas. The metallic sodium (1) that has been fed into a guillotine cutter (not shown) and sliced is dropped into the feed opening (5) in the upper part of the tube (4) inserted into the water tank (3) with the water (2) in it. Thus the metallic sodium descends into the water. Oil has been added to the water tank to create a thin film on the surface of the water and seal it off from air. The tube can be made of glass, a synthetic resin, or metal. The tube must be alkali-resistant; therefore, alkali-resistant glass or, to keep the weight down, a synthetic resin that is alkaline-safe is the desirable material. The further end of the tube is under the surface of the water and an oil film (6) covers the surface of the water within the tube.

The tube is open at the lower end. A water jet pump (7) is located under water in the water tank. A water ejection pipe (8) is connected to the water jet pump to carry away the water. The pipe is equipped with a number of suction slits (9) to suction off the water. There is an opening located between the slits and the water ejection hole at the extremity of the pipe where the water is drawn out. This opening is fixed to the lower end of the tube (4). Adhesive can be used to affix these. This design makes it possible for the fine metallic sodium slices that have dropped from the tube (4) to be immediately pushed into the middle of the water together with the water expelled by the water jet pump. The water jet pump can be placed anywhere within the water layer but it is best located 1 to 2 centimeters below the water's surface.

The metallic sodium that drops in together with the water expelled by the water jet pump is immediately forced into the water layer. For this reason, the hydrogen gas generated by the reaction of the metallic sodium and water does not flow backward into the tube (4) but is led to the gas takeout tube (10). Note: if it should happen that the water jet pump is not in operation the metallic sodium fed in will follow the oil film and descend into the water layer, react with the water in the water jet pump water ejection pipe, and generate hydrogen gas there. The hydrogen gas generated in this way has the possibility of flowing backward into the tube (4), which could cause a hazard.

The generated hydrogen gas is expelled through the gas takeout tube (10) located in the upper water tank, passed through a water-filled strainer (11) where water and other impurities are removed, and then passed through the gas takeout tube (13) and stored in a storage tank (not shown). There is a partition (12) in the strainer so that the hydrogen gas is led into the gas takeout tube (13) leading to the storage tank without any back flow. It is then stored in the storage tank. The pressure inside the storage tank is set at 3 atm. The storage tank is equipped with a pressure sensor. This sensor sends a signal to a pressure switch to turn the electric current on or off, activating or deactivating the metallic sodium supply. When the feeding supply device is a guillotine cutter, at any time the pressure in the storage tank exceeds the set limit the sensor is activated, cutting the switch and stopping the action of the metallic sodium supply device so that the metallic sodium ceases to be forced into the cutter. By this means the metallic sodium is no longer introduced into the water, thereby avoiding an excess of hydrogen gas generation. Further, a valve (14) in the gas takeout tube prevents back flow from the storage tank into the gas takeout tube (13).

Through a number of variant processes the hydrogen gas accumulated in the storage tank can be made available for a variety of uses; for example, as hydrogen fuel for an internal combustion engine; as fuel for a fuel cell; or as a synthetic raw material for chemical products.

A pump already available on the market may be used for the water jet pump.

Because sodium dissolves in the water in the tank after the water has reacted with molten metallic sodium in the generation of hydrogen gas, the amount of sodium hydroxide gradually increases. To deal with this situation, a drainage valve (15) has been attached to the water drainage pipe that exits at the bottom of the tank. After the sodium hydroxide solution has been drained out, a combination of water and oil is freshly introduced into the tank from the water drainage pipe to return the tank to its original state. The water with the high volume of extracted sodium hydroxide can be condensed and the metallic sodium recovered for reuse.

Metallic sodium can be obtained from molten sodium chloride by the electrolysis method or the amalgam method. In either case, the inventors have used power derived from solar energy as previously described in; Japanese Patent Application 2007-139788 and Japanese Patent Application 2007-156284. For this reason, for those countries whose oil or other energy resources are limited or nonexistent, the present invention represents a major contribution from the standpoint of energy resource acquisition.

### EMBODIMENT

The following is a concrete explanation of the present invention based on actual examples:

### Example 1

The apparatus used was that illustrated in Drawing 1. A homemade guillotine cutter was used to slice flat pieces if metallic sodium which were introduced through the feed opening and through the tube and allowed to drop. A water jet pump was attached to the tube exit. A water ejection pipe with suction slits was attached to the water jet pump. A hole was opened in the space between the suction slits and the water ejection pipe and the lower end of the tube was fixed to it with adhesive. The water jet pump used was an FP-15S made by the company Sendak. When the metallic sodium was introduced, it was immediately pushed under the water surface by the water current generated by the water jet pump and began to produce hydrogen gas bubbles as it circulated around the water layer.

The hydrogen gas thus produced passed through a strainer into the storage tank where it was held. The pressure within the storage tank was set at 3 atm. When the pressure within the tank approached 3 atm, the pressure switch attached to the pressure sensor was activated, the guillotine cutter action was stopped, and the supply of metallic sodium stopped with it. When the atm within the storage tank dropped significantly below 3 atm, the pressure switch turned on and the cutter action resumed, the supply of metallic sodium to the cutter was reactivated, and hydrogen gas was again being generated.

### Comparative Example 1

The only variation from Example 1 was the water jet pump was not activated in this example. In this case, the metallic sodium slices were introduced and stopped in the middle of the pump's water ejection pipe. They reacted with the water there to produce the hydrogen gas. Most of the hydrogen gas produced flowed back into the metallic sodium feeding tube, spilled out of the feed opening, and on coming into contact with the air produced a small explosion, thus presenting a hazard.

### INDUSTRIAL APPLICABILITY

As has been described above, the present invention makes it possible to safely generate hydrogen gas through the reaction of metallic hydrogen with water. Hydrogen gas can be utilized in an internal combustion engine in place of gasoline and therefore represents an effective energy source. Moreover, hydrogen gas can be used as the fuel for fuel cells and also as a raw material for chemical products.

Explanation of Drawing

1 metallic sodium

2 water

3 water tank

4 feeding tube

5 feed opening

6 oil film surface

7 water jet pump

8 water ejection pipe

9 suction slits

10 gas takeout tube

11 strainer

12 partition

13 gas takeout tube

14 back flow prevention valve

15 drainage valve

1. An apparatus for generating hydrogen gas comprising: a metallic sodium feed pipe provided with a feed opening for feeding pieces of cut metallic sodium into a water layer in a sealed water tank; and a water jet pump located below water level in the water tank.

2. The apparatus according to claim 1 wherein a water ejection pipe is connected to the water jet pump; water-sucking slits are provided in the water ejection pipe; and the lower end of the metallic sodium pipe is fixed in place in a hole provided between the slits and the end of the water ejection pipe.

3. A device to supply metallic sodium that has been molded in bars or plates to the guillotine cutter and a guillotine cutter such that when the expelled metallic sodium comes in contact with the stopper an electric signal is released causing the upper blade of the cutter to fall and sever the metallic sodium: by these means the metallic sodium is made available to generate the hydrogen gas, as outlined in Claim Item 1.
